(19) United States
(12) Patent Application Publication
(10) Pub. No.: US 2011/0167600 A1
(43) Pub. Date: Jul. 14, 2011

(54) LOAD BINDER

(76) Inventor: James Michael Keevy, Turramurra (AU)

(21) Appl. No.: 13/004,199

(22) Filed: Jan. 11, 2011

(30) Foreign Application Priority Data
Jan. 12, 2010 (AU) 2010900080

(51) Int. Cl. B60P 7/00

(52) U.S. Cl. 24/68 CD

(57) ABSTRACT

A load binder is described for securing a load to a vehicle or the like, the load binder including: attachment means for attaching a flexible member to be tensioned by the load binder; an over-centre mechanism; an operating lever; and a ratchet mechanism; the load binder is moveable between a tensioned configuration and a released configuration by way of the operating lever; and wherein the ratchet mechanism allows the load binder to be progressively moved from the released configuration to the tensioned configuration.

### TECHNICAL FIELD

The present invention relates to load binders and particularly relates to an over centre type of load binder with a safety tension and release action.

### BACKGROUND TO THE INVENTION

Load binders are used to secure a load on a vehicle or the like. A load binder is used to tension a rope, strap or chain or the like, which holds the load in place during transit. The load binder is released at the time that the load is to be unloaded from a vehicle.

A conventional over-centre type load binder (sometimes referred to as a “dog”) includes an elongated operating lever attached to a crank portion. A chain or the like is attached to the load binder. Tension is created in the chain by rotating the lever such that the crank rotates through a dead centre position from an open or load release position to an over centre position. The configuration of the elongated lever is such that a considerable mechanical advantage is created by which a significant tensile force is created in the chain or like to secure a load.

However, it has been found that both tensioning and releasing the device can be highly dangerous. In tensioning the device, the user applies a tension to the handle. However the device can twist as the chain or like stretches or the user may not have the strength to place the device over centre which can cause the handle to leave the users hand and recoil or “flyback” unrestrained. Similarly, in releasing the device, the handle is subjected to sudden forces which can also cause the handle to leave the user's hand and flyback. This flyback can cause serious injury.

Some have tried using a lost-motion arrangement involving a pivotal connection between the crank and the lever. In this way, when releasing a tensioned load binder, there is a loss of motion between the crank and the handle, which avoids the problem of flyback. However, such devices are still prone to flyback during the operation of tensioning the device.

There remains a need to provide improved load binding devices which pose less risk of injury to operators.

### SUMMARY OF THE INVENTION

In a first aspect the present invention provides a load binder for securing a load to a vehicle or the like, the load binder including: attachment means for attaching a flexible member to be tensioned by the load binder; an over-centre mechanism; an operating lever; and a ratchet mechanism; the load binder is moveable between a tensioned configuration and a released configuration by way of the operating lever; and wherein the ratchet mechanism allows the load binder to be progressively moved from the released configuration to the tensioned configuration.

The ratchet mechanism may further allow the load binder to be progressively moved from the tensioned configuration to the released configuration.

The over-centre mechanism may include a crank, and a pawl of the ratchet mechanism is mounted in association with the crank.

The crank may be provided in at least two parts, each being disposed on either side of the teeth of the ratchet mechanism.

The operating lever may be pivotally mounted to the crank.

The attachment means may be provided in at least two parts, each being disposed on either side of the teeth of the ratchet mechanism.

The operating lever may include a projection which releases the ratchet mechanism.

### BRIEF DESCRIPTION OF THE DRAWINGS

An embodiment of the present invention will now be described, by way of example only, with reference to the accompanying drawings, in which:

FIG. 1 is a side view of an embodiment of a load binder according to the present invention shown in its tensioned configuration;

FIG. 2 is a perspective view of the load binder of FIG. 1;

FIG. 3 is a side view of the tension piece of the load binder of FIG. 1;

FIG. 4 is a side view of the handle of the load binder of FIG. 1;

FIG. 5 is a side view of the components of the crank of the load binder of FIG. 1;

FIG. 6 is a partial top view of the load binder of FIG. 1;

FIG. 7 is a side view of the load binder of FIG. 1 in the released configuration;

FIGS. 8a, 8b, and 8c are a sequence of partial side views illustrating moving the load binder of FIG. 1 to the tensioned position; and

FIGS. 9a, 9b & 9c are a sequence of partial side views illustrating moving the load binder of FIG. 1 to the released position.

### DETAILED DESCRIPTION OF THE PREFERRED EMBODIMENT

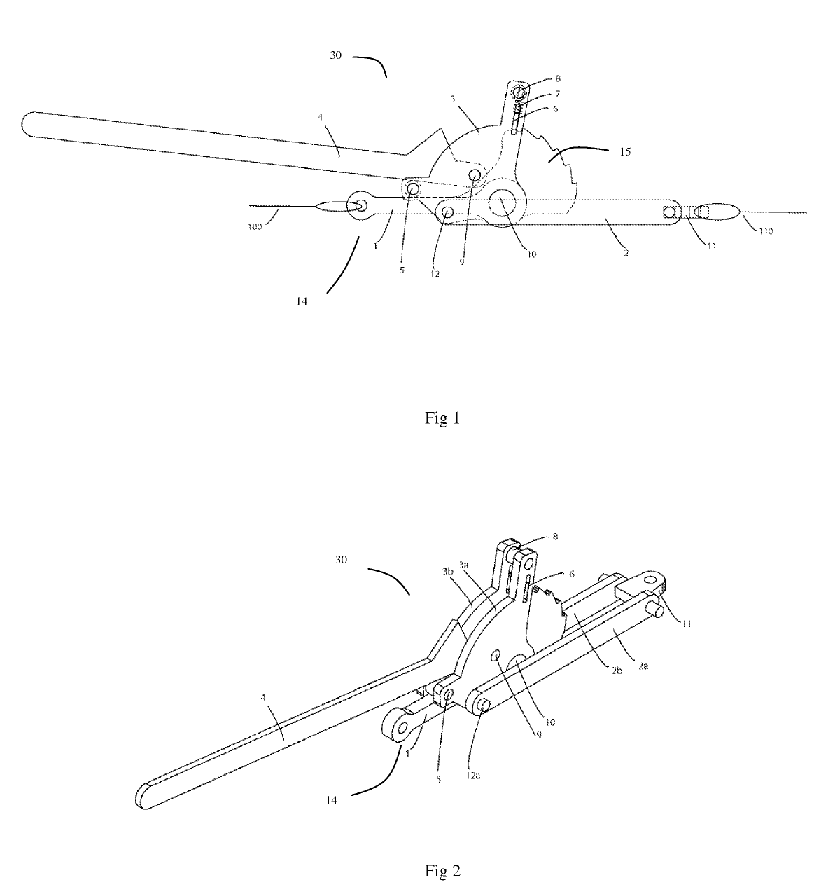

Referring to FIGS. 1 and 2, a load binder 30 is shown. The load binder includes attachment means for attaching to a flexible member in the form of eye 14 provided in tension piece 1, and a similar eye provided in connector 11. In the figure, ends of a flexible member tie-down in the form of a rope 100, 110, are shown in schematic form attached to the attachment means.

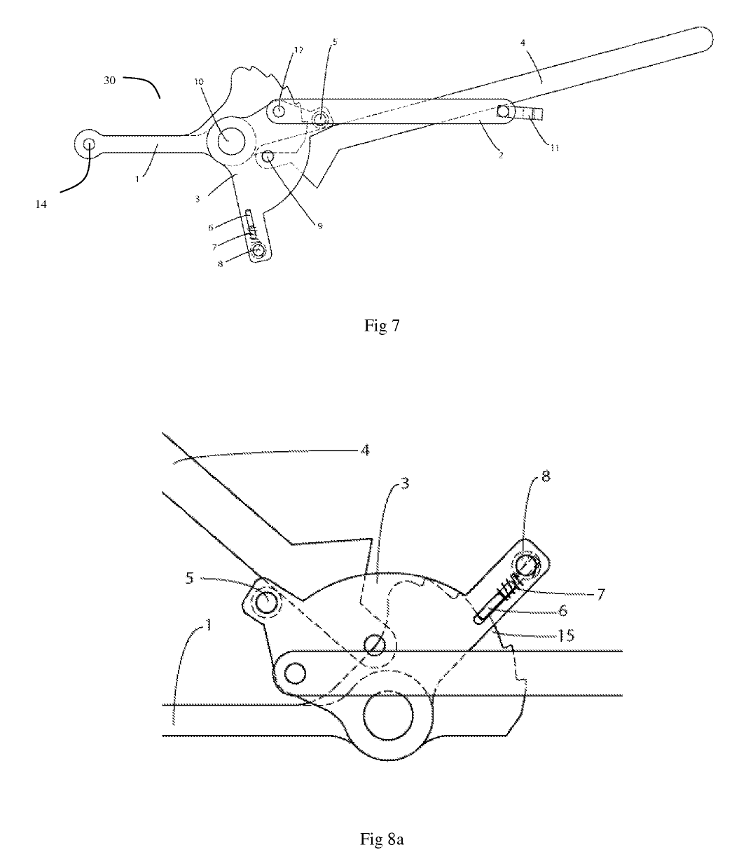

Load binder 30 further includes an over centre mechanism formed by the linkage of tension members 2a, 2b, crank 3, and tension piece 1 as will be further explained. A ratchet mechanism is formed by the teeth on gear portion 15 and pawl 6. An operating lever is provided in the form of handle 4 which is pivotally mounted to crank 3 by way of pin 9. Load binder 30 is moveable by way of handle 4 between a tensioned configuration (as shown in FIGS. 1 & 2) and a released position (as shown in FIG. 7). The ratchet mechanism allows the load binder to be progressively moved between the two configurations, as will become apparent from the following detailed description.

Tension member 2 consists of two components 2a, 2b which are provided on either side of crank 3. The crank 3 is connected to each tension member 2a, 2b by pins 10 and 12a, 12b which allow the pivoting of the tension members with respect to crank 3. Crank 3 consists of two identical members 3a, 3b connected together via cross members 5 and 8 with each component situated on either side of the tension member 1. The handle 4 is connected only to component 3a of the crank via pin 9 and is situated between the two crank pieces. The pawl 6 is biased towards teeth of gear 15 by way of compression spring 7 which acts against cross member 8.

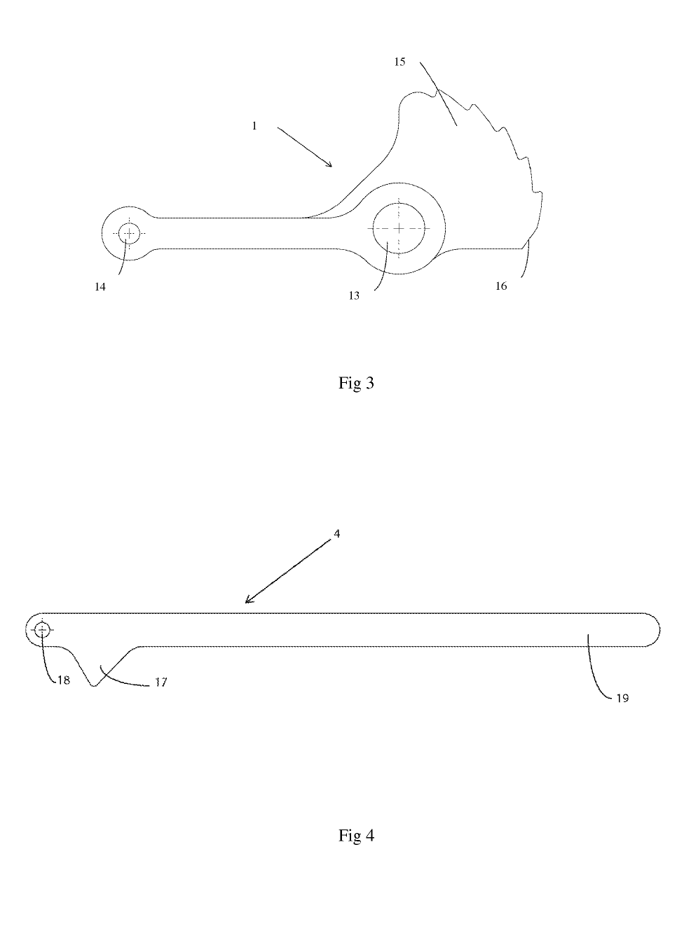

Referring to FIG. 3, tension piece 1 is shown in enlarged detail. Hole 13 is the location by which pin 10 passes through the component to attach to crank components 3a and 3b. Eye 14 is where the tension piece attaches to tie down 100 by means of a hook or similar with a swivel to prevent adverse effects of twisted tie down. In use, tension is applied in the member between hole 13 and eye 14. Tension piece 1 includes a quarter circle gear 15 which bears ratchet teeth at a constant radius from the centre of hole 13. The direction of the teeth is such that, upon engagement with the crank, rotation is only allowed towards the tensioned position. The ratchet begins at face 16 whose radius is closer to the centre of hole 13 than the pawl to allow re-engagement of the pawl.

Referring to FIG. 4, handle 4 is shown in enlarged detail. Handle 4 includes a hole 18 by which it connects to crank component 3a by way of pin 9 (see FIG. 1). Handle 4 is elongate and is intended to be grasped at the region labelled reference numeral 19 to create a mechanical advantage when tightening. Handle 4 includes a projection 17 which lifts the pawl 6 during release, detailed later.

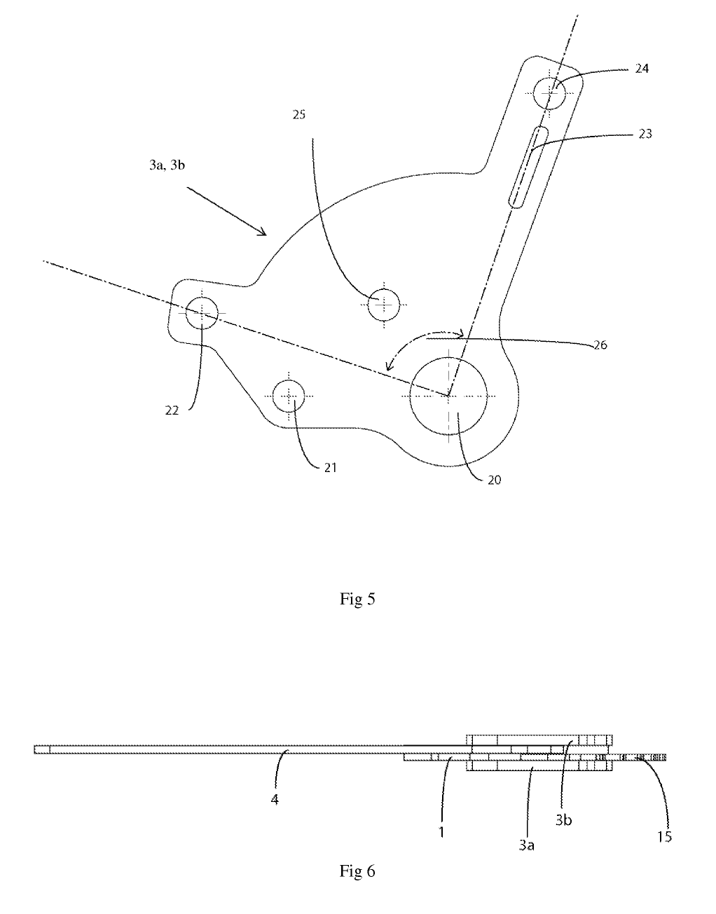

Referring to FIG. 5, one of the identical crank components 3a, 3b is shown in enlarged detail. Hole 20 is for pin 10 which connects the crank pieces together and to tension member 1. Hole 21 is where crank components 3a, 3b connect to pins 12a and 12b respectively, which connect the crank to tension members 2a and 2b respectively. Cross member 5 passes through hole 22 to link the two crank members together.

Similarly, cross member 8 passes through hole 24 on each crank component. Slot 23 is a positioning guide for pawl 6. Hole 25, while present on both crank members 3a and 3b, only hole 25 on component 3a is used to connect the handle 4 via pin 9. Angle 26 is between hole 22 and 24 with radius centre at hole 20. Pin 9 is situated within this angle such that the free rotation of handle 4 about pin 9 is limited by the cross members 5 and 8 (see FIG. 1). The required arc of movement is determined by the width of the ratchet teeth 15, with the angle of free rotation required to be at least twice the angle between the major and minor radius of the ratchet teeth 15.

Referring to FIG. 6, it is evident that the handle 4 and ratchet teeth feature 15 of tension member 1 each only take up part of the distance between crank members 3a and 3b. This allows handle 4 to rotate within the two crank components 3a and 3b simultaneously with feature 15 of tension member 1 such that they do not interfere with each other.

Referring to FIG. 7, load binder 30 is shown in the released configuration. It can be seen that pawl 6 is not engaged with the ratchet teeth 15 of tension member 1. Comparing with FIG. 1, it can be seen that the distance between hole 14 and connector 11 is greater in FIG. 7 than in FIG. 1. It is this change in distance that causes the tie-down attached to the load binder to be either tensioned, or released.

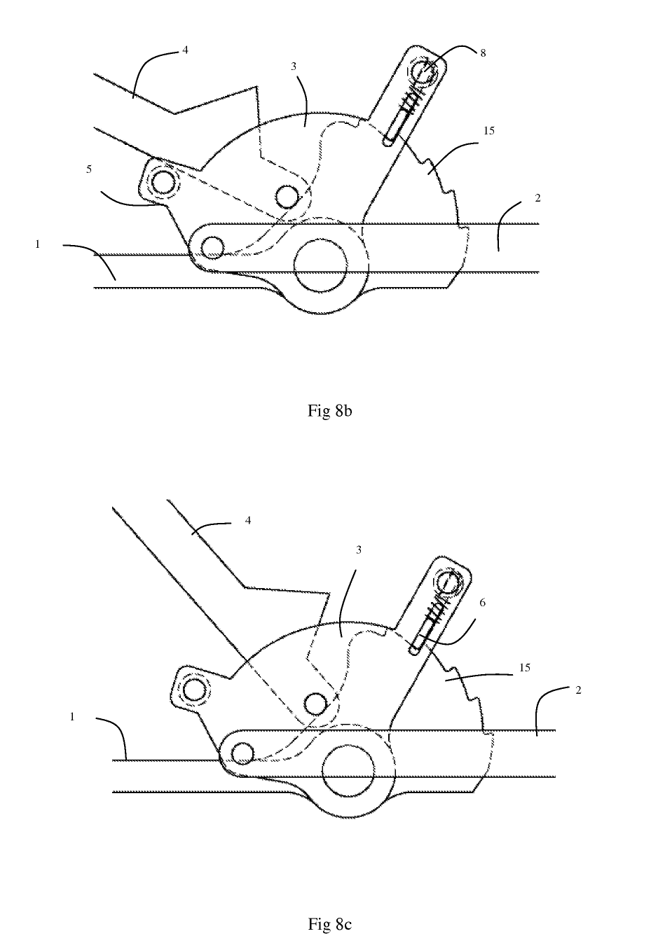

Referring to the sequence of figures, 8a, 8b & 8c, the operation of putting the load binder into the tensioned configuration will be explained. At FIG. 8a, handle 4 is being pushed in an anti-clockwise direction. Handle 4 presses against cross member 5 to rotate crank in an anti-clockwise direction. The rotation of the crank 3 causes the pawl 6 to slide along the ratchet teeth of gear 15, compressing spring 7. Once the crank 3 rotates equivalent to the angular distance between the ratchet teeth of feature 15, the pawl reaches the next ratchet tooth and is pushed against the tooth by the spring 7. At FIG. 8b, the crank has rotated one gear tooth further than seen in FIG. 8a.

Referring to FIG. 8c, the load binder has not yet been fully brought to the tensioned position, however, handle 4 has been rotated in a clockwise direction back away from cross member 5. As can be seen, the tension applied between tension member 1 and 2 is not transferred to crank 3 due to pawl 6 being pressed against a ratchet tooth of feature 15. The pawl 6 holds the tension by preventing the crank 3 from rotating around tension member 1, which in turn prevents cross member 5 contacting handle 4 in turn preventing “flyback” or recoil of the handle 4. In this way, the load binder can be progressively moved from the released position to the tensioned position in a safe and controlled manner.

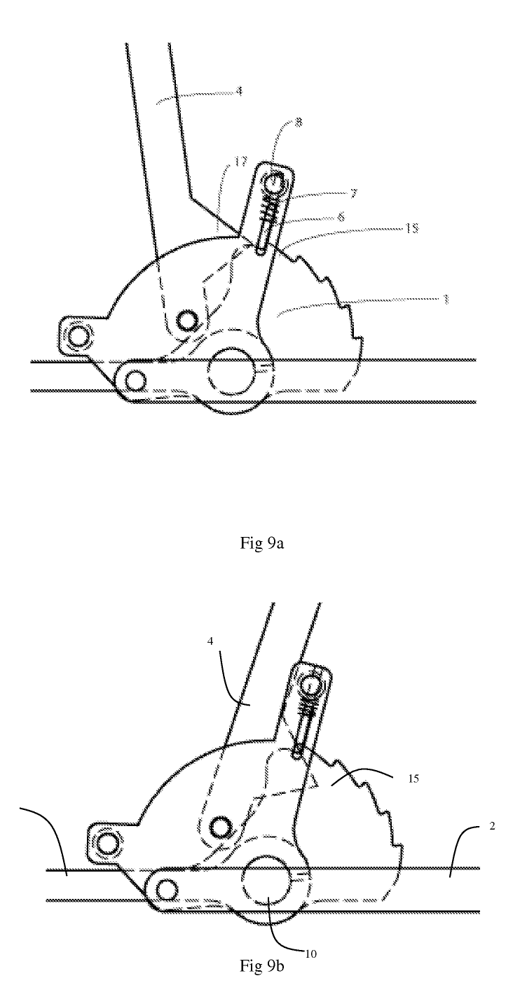

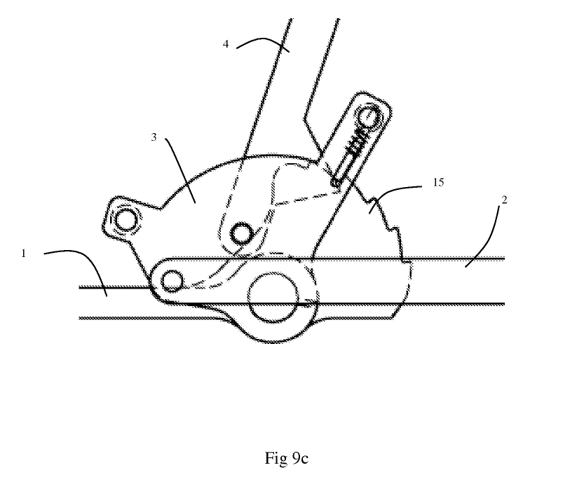

Continued rotation of handle 4 in the anti-clockwise direction results in the load binder reaching the tensioned configuration as seen in FIG. 9a. In this position, the crank 3 has reached an over-centre position, which is evident from the fact that the centre of pin 10 is now above the level of the centre line of tension member 2. The load-binder is held by the tension in the tie down and no force is exerted on any of the teeth 15.

Referring to FIGS. 9a, 9b and 9c, the operation of moving the load binder from the tensioned position to the released position will be explained. In FIG. 9a, handle 4 is being rotated around crank 3 in a clockwise direction towards the pawl 6. Pawl 6 in this position is in contact with a ratchet tooth 15 of tension member 1 and pressed toward the centre of the device by compression spring 7 bearing against cross member 8. In FIG. 9b, handle has been rotated further towards pawl 6. Projection 17 lifts pawl 6 from the ratchet tooth against the compression of spring 7. FIG. 9c shows that, pawl 6 has been lifted to the extent that contact with the ratchet tooth has been lost, the crank 3 rotates around tension member I as the tension applied by the device applies a force to increase the distance between the tension members 1 and 2. The compression generated in spring 7 acts to push pawl 6 back in contact with the next tooth of gear 15 during rotation of the crank 3, preventing further rotation. Further rotation of handle 4 toward the pawl will lead to further tension release until all tension generated by the device is released and the pawl rotates past all ratchet teeth on feature 15 to adopt the released configuration seen in FIG. 7. In this way, the load binder can be progressively moved from the tensioned configuration to the released configuration whilst avoiding “flyback” or recoil of the handle 4.

In other embodiments, a swivel is provided at or near the tie down attachment points to avoid twisting forces on the load binder such as might be caused by a twisted tie down.

In some embodiments, a clip, lock or like is provided to hold the lever 4 against cross member 5 which would aid in further reducing possible flyback during tensioning and prevent accidental release during load transport.

In some embodiments, handle 4 may be modified to be made removable. By removing handle 4, projection 17 is also removed, which would prevent accidental release and the device would also take up less volume during transit.

It can be seen that embodiments of the invention have at least one of the following advantages:

The load binder can be put into the tensioned configuration progressively, rather than in one movement, as is the case with prior art devices. Thus, the problem of “flyback” during tensioning is avoided.

The load binder can be progressively moved to the released configuration, thus avoiding flyback during releasing the load binder.

Any reference to prior art contained herein is not to be taken as an admission that the information is common general knowledge, unless otherwise indicated.

Finally, it is to be appreciated that various alterations or additions may be made to the parts previously described without departing from the spirit or ambit of the present invention.

1. A load binder for securing a load to a vehicle or the like, the load binder including:
attachment of a flexible member to be tensioned by the load binder;
an over-centre mechanism;
an operating lever; and
a ratchet mechanism;
the load binder is moveable between a tensioned configuration and a released configuration by way of the operating lever; and
wherein the ratchet mechanism allows the load binder to be progressively moved from the released configuration to the tensioned configuration.

2. A load binder according to claim 1 wherein the ratchet mechanism further allows the load binder to be progressively moved from the tensioned configuration to the released configuration.

3. A load binder according to claim 2 wherein the over-centre mechanism includes a crank, and a pawl of the ratchet mechanism is mounted in association with the crank.

4. A load binder according to claim 3, wherein the crank is provided in at least two parts, each being disposed on either side of the teeth of the ratchet mechanism.

5. A load binder according to claim 4 wherein the operating lever is pivotally mounted to the crank.

6. A load binder according to claim 1 wherein the attachment is provided in at least two parts, each being disposed on either side of the teeth of the ratchet mechanism.

7. A load binder according to claim 1 wherein the operating lever includes a projection which releases the ratchet mechanism.

8. A load binder according to claim 3 wherein the operating lever is pivotally mounted to the crank.

9. A load binder according to claim 1 wherein the over-centre mechanism includes a crank, and a pawl of the ratchet mechanism is mounted in association with the crank.

10. A load binder according to claim 9, wherein the crank is provided in at least two parts, each being disposed on either side of the teeth of the ratchet mechanism.

11. A load binder according to claim 10 wherein the operating lever is pivotally mounted to the crank.

12. A load binder according to claim 9 wherein the operating lever is pivotally mounted to the crank.
